(19) United States
(12) Patent Application Publication
(10) Pub. No.: US 2025/0013822 A1
(43) Pub. Date: Jan. 9, 2025

(54) ADVERB DICTIONARY UPDATE APPARATUS AND ADVERB DICTIONARY UPDATE METHOD

(71) Applicant: Hitachi, Ltd., Tokyo (JP)

(72) Inventors: Ai Toshikuni, Tokyo (JP); Tadahisa Kato, Tokyo (JP); Toshiki Maeno, Tokyo (JP); Kazuyoshi Karatsuya, Tokyo (JP)

(21) Appl. No.: 18/628,518

(22) Filed: Apr. 5, 2024

(30) Foreign Application Priority Data
Jul. 6, 2023 (JP) 2023-111386

(51) Int. Cl. G06F 40/242; G06Q 30/0203

(52) U.S. Cl. CPC G06F 40/242; G06Q 30/0203

(57) ABSTRACT

An adverb dictionary update apparatus that updates an adverb dictionary used for emotion degree estimation includes a text data acquisition unit that acquires text data includes an object of the emotion degree estimation and stores the text data in a text set storage unit, a text data adverb extraction unit that extracts adverbs related to each piece of text data from the text set storage unit and stores the extracted adverbs in an adverb set storage unit, and an unregistered adverb degree value assignment unit that reads a list of the extracted adverbs from the adverb set storage unit, that reads, from an adverb dictionary storage unit, an adverb dictionary including, as a table, registered adverbs and degree values, that updates the adverb dictionary by assigning a degree value to an unregistered adverb among the extracted adverbs while referring to the degree values of the registered adverbs.

### TECHNICAL FIELD

The present invention relates to an adverb dictionary update apparatus and an adverb dictionary update method that are used for processing of content of text data while focusing on emotions.

### BACKGROUND ART

Conventionally, services and products cannot be developed without evaluation (such as quality in use or net promoter score (NPS)) from the users' viewpoint. In addition, it is required to collect detailed voices of customers on a social networking service (SNS) where it is possible to pick up voices of more people than by questionnaires and on review sites.

For example, there is disclosed an information processing apparatus that can collect preference information of users who use an Internet service on which content including at least one of an image (including a photograph (still image) and a moving image constituted by a series of still images) and a text is posted (See PTL 1). PTL 1 (paragraph) describes that “As illustrated in FIG. 9, the preference tendency analysis unit 205 previously creates and stores a table for determining the level of preference for a large number of adverbs, and estimates the level of subjective preference of the viewer him or herself by referring to the adverbs extracted by the language analysis unit 203”.

### CITATION LIST

### Patent Literature

PTL 1: JP 2021-092931 A

### SUMMARY OF INVENTION

### Technical Problem

As described above, there has been a study of calculating the degree of an adverb using an emotion dictionary (also referred to as adverb dictionary). However, with respect to an adverb dictionary created at a certain point of time (certain days), new words increase, and degree values change with the passage of time (a flow of time). Therefore, a method is desired that can update the adverb dictionary in accordance with the passage of time. PTL 1 describes “The table should be added and updated as needed” (paragraph [0031]), but does not disclose a specific method for updating the emotion dictionary.

The present invention has been made in view of the above circumstances, and an object of the invention is to propose a method for updating an adverb dictionary in accordance with the passage of time.

### Solution to Problem

To solve the above problems, an adverb dictionary update apparatus of one aspect of the present invention updates an adverb dictionary used for emotion degree estimation, and the apparatus includes: a text data acquisition unit that acquires text data including an object of the emotion degree estimation and stores the text data in a text set storage unit; a text data adverb extraction unit that extracts adverbs related to each piece of text data from the text set storage unit and stores the extracted adverbs in an adverb set storage unit; and an unregistered adverb degree value assignment unit that reads a list of the extracted adverbs from the adverb set storage unit, that reads, from an adverb dictionary storage unit, an adverb dictionary including, as a table, registered adverbs and degree values, that updates the adverb dictionary by assigning a degree value to an unregistered adverb among the extracted adverbs with reference to the degree values of the registered adverbs, and that stores the updated adverb dictionary in the adverb dictionary storage unit.

### Advantageous Effects of Invention

With at least one aspect of the present invention, it is possible to support update and maintenance of an emotion dictionary.

The following description of an embodiment clarifies problems and advantageous effects other than the above-described ones.

### BRIEF DESCRIPTION OF DRAWING

FIG. 1 is a diagram illustrating an outline of an emotion object degree estimation method.

FIG. 2 is a diagram illustrating an example of an emotion degree estimation method including an adverb dictionary update function according to a first embodiment of the present invention.

FIG. 3 is a block diagram illustrating an internal configuration example of an adverb dictionary update apparatus that realizes the emotion degree estimation method according to the first embodiment of the present invention.

FIG. 4 is a flowchart illustrating a procedure example of a process of an unregistered adverb degree value assignment unit according to the first embodiment of the present invention.

FIG. 5 is a block diagram illustrating an internal configuration example of an adverb dictionary update apparatus that realizes the emotion degree estimation method according to a second embodiment of the present invention.

FIG. 6 is a diagram illustrating an example of a user interface screen for checking degree values of adverbs in each embodiment of the present invention.

FIG. 7 is a diagram for explaining a function of user's check of an adverb dictionary in each embodiment of the present invention.

FIG. 8 is a diagram illustrating an example of a user interface screen of an adverb dictionary maintenance tool in each embodiment of the present invention.

FIG. 9 is a block diagram illustrating a hardware configuration example of a control system of the adverb dictionary update apparatus according to each embodiment of the present invention.

### DESCRIPTION OF EMBODIMENTS

Hereinafter, examples of a mode for carrying out the present invention (hereinafter, referred to as “embodiment”) will be described with reference to the accompanying drawings. In the present specification and the accompanying drawings, the same components or components having substantially the same function are denoted by the same reference signs, and a redundant description is omitted.

### First Embodiment

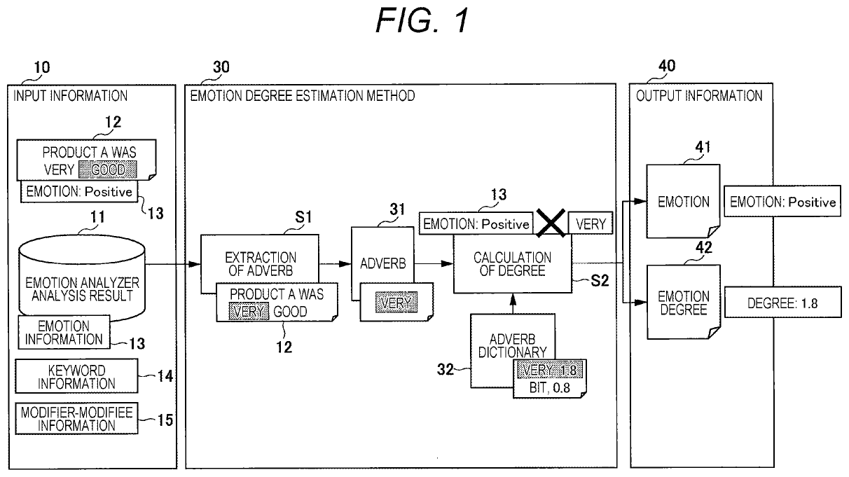

First, an information processing apparatus according to a first embodiment of the present invention will be described with reference to FIGS. 1 to 4.

FIG. 1 is a diagram illustrating an outline of an emotion degree estimation method. An emotion degree estimation method 30 illustrated in FIG. 1 estimates degrees of emotion from input information 10 and outputs estimation results of the degrees of emotion as output information 40. The emotion degree is information that indicates three main classifications of emotions (favorable/positive, uncommitted/neutral, malicious/negative) and, in addition, indicates the level (strength) of each classification of emotion. An object sentence (text data) that is an analysis object of the emotion analyzer analysis result 11 is input, as the input information 10, to the emotion degree estimation method 30.

The emotion analyzer analysis result 11 is information output from an emotion analyzer (not shown) and is information in which information of an object sentence (text data) such as SNS data or business data is associated with a result of emotion analysis of the object sentence. For example, FIG. 1 illustrates an example. In the example, text data 12 saying “Product A was very good” is the object sentence to be subjected to emotion analysis, and emotion information 13, keyword information 14, and modifier-modifiee information 15 are output, as an example, with respect to the input of the object sentence.

The emotion information 13 is information of the result of the determination of which emotion the object sentence has, for example, positive, negative, or neutral. In FIG. 1, the emotion information 13 for the text data 12 is determined to be “Positive”.

The keyword information 14 is information in which the keywords included in the object sentence are listed. For example, the keywords are classified as “A: proper noun”, “product: noun”, and “good: adjective” are classified. The modifier-modifiee information 15 is information in which modifier-modifiee relations in the object sentences are listed. For example, “Modifier: A, Modifiee: product”.

These three pieces of information are examples of the information used in the present invention, and are excerpts from the results of emotion analysis, and the emotion analyzer outputs various other pieces of information by natural language processing.

The emotion degree estimation method 30 is a processing unit that estimates an emotion degree of an object sentence. The emotion degree estimation method 30 extracts, as an emotion expression, an adverb 31 from the object sentence (S1), and calculates the emotion degree of the object sentence on the basis of the adverb 31 extracted while referring to the adverb dictionary 32 (S2). The adverb is generally a part of speech that modifies a property or a state of an object. The adverb dictionary 32 is a table whose records include combinations of adverbs and degree values that are information indicating the level of the adverb. Then, the emotion degree estimation method 30 outputs emotion information 41 and an emotion degree 42 with respect to the object sentence. The emotion information 41 is the emotion information 13. For example, FIG. 1 illustrates an example. In the example, “very” is extracted as the adverb 31, “Positive” is output as the emotion information 41, and “1.8” is output as the emotion degree 42.

The emotion degree estimation method 30 outputs the output information 40 as the result of estimation processing on the input information 10. The output information 40 includes the emotion information 41 and the emotion degree 42 that are output from the emotion degree estimation method 30. FIG. 1 illustrates an example of the output information 40 in which the emotion information 41 with respect to the text data 12 is “Positive” and the emotion degree 42 is “1.8”.

In the emotion degree estimation method, an adverb dictionary (emotion dictionary) is previously created, and a calculation formula for calculating the degree is defined. In the present embodiment, a system of adverbs representing levels is organized, and degree values are set for representative adverbs on the basis of subjective view of human.

For example, in the adverb dictionary, the degree of adverb is set in a range from “0” to “2”. The value “1” is a reference value. The reference value may be alternatively read as the standard value. For example, because the adverb “considerably” seems to have a high level according to the subjective view of human, the value 1.8 in the range from 0 to 2 of the degree value is set. The adverb dictionary may be created on the basis of subjective views of a plurality of persons by questionnaires or the like. In that case, the levels with respect to an adverb is acquired from a plurality of persons by way of questionnaires, and the degree value is calculated statistically using an average value, a variance value, or an intermediate value. In this way, the combinations of adverbs and degree values are defined, thereby creating an adverb dictionary functioning as a reference.

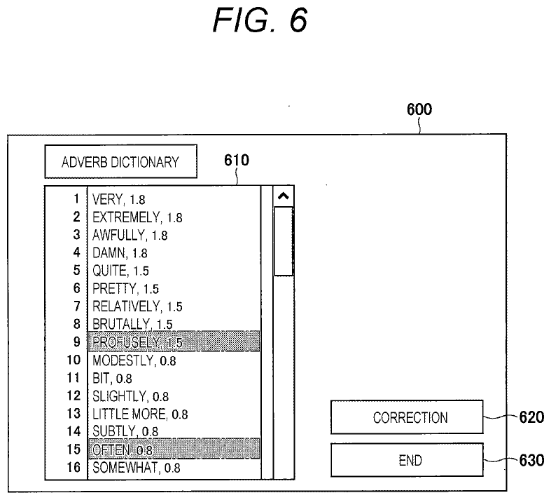

The degree value of an adverb can be set as follows, for example. As illustrated in FIG. 6 to be described later, the degree value of “1.8” can be set in the case of an adverb at a high level (very, extremely, and the like), the degree value of “1.5” can be set in the case of an adverb at a medium level (quite, pretty, and the like), and the degree value of “0.8” can be set in the case of an adverb at a low level (modestly, slightly, and the like).

In the calculation of degree (S2) in the emotion degree estimation method 30, the emotion degree is calculated from the main classification of emotion and the degree value of the adverb. As the degree calculation formula, the following two formulas can be used, for example.

Degree calculation formula 1 (multiplication formula)=main classification of emotion (+1.0,0,−1.0)×Π adverb degree value Degree calculation formula 2 (addition formula)=main classification of emotion (+1.0,0,−1.0)+Σ (adverb degree value−1.0)

Here, the value “+1.0” is set for “favorable”, the value “0” is set for “uncommitted”, and the value “−1.0” is set for “malicious”. The mathematical symbol Π in Degree calculation formula 1 and the mathematical symbol Σ in Degree calculation formula 2 respectively indicate that, for example, in a case where a plurality of adverbs are included in the sentence to be analyzed: multiplication of the degree value is performed for the number of the adverbs; and addition of the degree values is performed for the number of the adverbs.

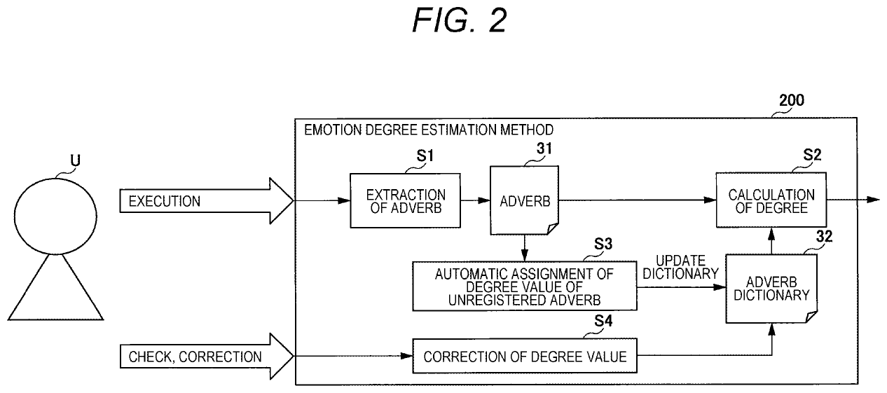

FIG. 2 is a diagram illustrating an example of an emotion degree estimation method including an adverb dictionary update function for updating the adverb dictionary according to the present embodiment. An emotion degree estimation method 200 illustrated in FIG. 2 is different from the emotion degree estimation method 30 illustrated in FIG. 1 in that the emotion degree estimation method 200 has an update function of updating the adverb dictionary 32. Specifically, the emotion degree estimation method 200 includes, as the update function of updating the adverb dictionary 32: a function (S3) of automatically assigning a degree value of an unregistered adverb; and a function (S4) of correcting the degree value.

When a user U of the emotion analyzer requests provision (execution) of the present service, the text data 12 (object sentence) that is the analysis object of the emotion analyzer analysis result 11 is input to the emotion degree estimation method 200. When the adverb 31 extracted from the text data is an unregistered adverb, the emotion degree estimation method 200 automatically assigns a degree value to the unregistered adverb 31 (S3) and updates the adverb dictionary 32. In the degree calculation (S2), the emotion degree of the text data 12 is estimated with reference to the updated adverb dictionary 32. For example, in the automatic degree-value assignment, when a large number of adverbs are added, the degree values are estimated in accordance with the similarities with the existing adverbs and assigned to the added adverbs.

In addition, the emotion degree estimation method 200 has a function (S4) with which the user U checks the degree value of an adverb registered in the adverb dictionary 32 and corrects the degree value. In degree value manual correction, the automatically assigned degree value can be appropriately corrected manually. However, the degree value correction function may be configured to automatically correct the degree value.

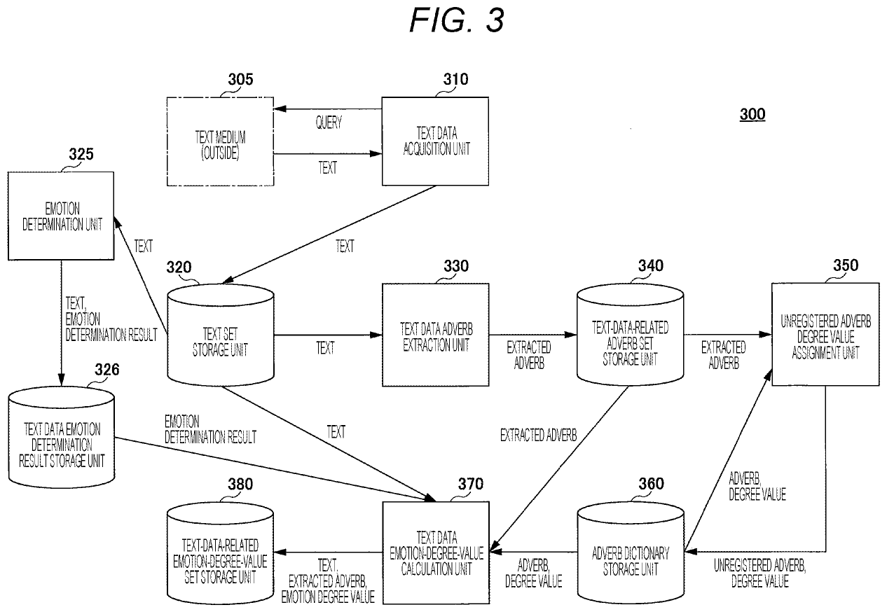

Next, a configuration of the adverb dictionary update apparatus that realizes the emotion degree estimation method 200 will be described with reference to FIG. 3.

FIG. 3 is a block diagram illustrating an internal configuration example of an adverb dictionary update apparatus that realizes the emotion degree estimation method 200. An adverb dictionary update apparatus 300 illustrated in FIG. 3 includes: a text data acquisition unit 310; a text set storage unit 320, a text data adverb extraction unit 330, a text-data-related adverb set storage unit 340 (an example of the adverb set storage unit); and an unregistered adverb degree value assignment unit 350. The adverb dictionary update apparatus 300 further includes: an adverb dictionary storage unit 360; a text data emotion-degree-value calculation unit 370; and a text-data-related emotion-degree-value set storage unit 380 (an example of an emotion-degree-value set storage unit). Furthermore, the adverb dictionary update apparatus 300 includes: an emotion determination unit 325; and a text data emotion determination result storage unit 326.

The text data acquisition unit 310 transmits a query to a text medium 305 provided outside the adverb dictionary update apparatus 300, and acquires the text data corresponding to the query from the text medium 305. In the present embodiment, the emotion analyzer analysis result 11 illustrated in FIG. 1 is used for the text medium 305. The query is an extraction condition (specification of a search target, a range, and the like) of text data, and is, for example, “washing machine of H company”, “year, month, day”, or the like. The text data acquisition unit 310 stores the acquired text data in the text set storage unit 320.

The text data adverb extraction unit 330 extracts an adverb related to each piece of text data stored in the text set storage unit 320 and stores the extracted adverbs in the text-data-related adverb set storage unit 340.

The unregistered adverb degree value assignment unit 350 reads a list of extracted adverbs from the text-data-related adverb set storage unit 340 and reads, from the adverb dictionary storage unit 360, an adverb dictionary (the adverb dictionary 32 in FIG. 2) having a table of registered adverbs and degree values. Then, the unregistered adverb degree value assignment unit 350 updates the adverb dictionary 32 by adding a degree value to an adverb, among the extracted adverbs, not registered in the adverb dictionary 32, and stores the adverb dictionary 32 in the adverb dictionary storage unit 360.

The emotion determination unit 325 reads each piece of text data from the text set storage unit 320. Then, the emotion determination unit 325 determines an emotion of each piece of text data, and stores a combination of each piece of text data and the obtained emotion determination result in the text data emotion determination result storage unit 326.

As can be understood from the above description, the emotion determination unit 325 and the text data emotion determination result storage unit 326 correspond to the input side of the emotion degree estimation method 200 illustrated in FIG. 2. For example, the text data emotion determination result storage unit 326 may be considered to correspond to the emotion analyzer analysis result 11 in FIG. 1.

The text data emotion-degree-value calculation unit 370 reads each piece of text data from the text set storage unit 320, the emotion determination result for each piece of text data from the text data emotion determination result storage unit 326, the extracted adverbs from the text-data-related adverb set storage unit 340, and the adverb dictionary 32 from the adverb dictionary storage unit 360. Then, the text data emotion-degree-value calculation unit 370 calculates the degree value of emotion of each piece of text data, and stores each piece of text data, the extracted adverbs, and the degree values of emotion as a table in the text-data-related emotion-degree-value set storage unit 380.

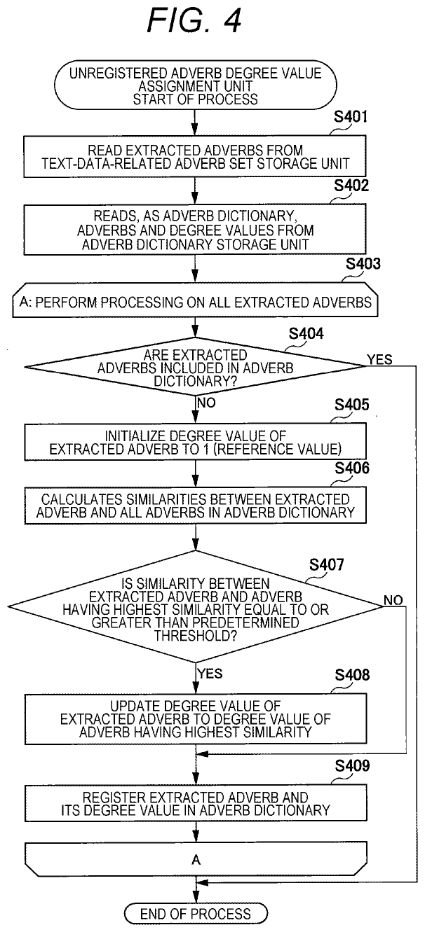

Next, the procedure of processing of the unregistered adverb degree value assignment unit 350 will be described with reference to FIG. 4.

FIG. 4 is a flowchart illustrating a procedure example of the processing of the unregistered adverb degree value assignment unit 350.

First, the unregistered adverb degree value assignment unit 350 reads the extracted adverbs from the text-data-related adverb set storage unit 340 (step S401). In addition, the unregistered adverb degree value assignment unit 350 reads, as the adverb dictionary 32, adverbs and degree values from the adverb dictionary storage unit 360 (step S402).

Next, the unregistered adverb degree value assignment unit 350 executes loop processing A including the processes from step S404 to step S409 for all the extracted adverbs (S403).

In the loop processing A, the unregistered adverb degree value assignment unit 350 first determines whether the extracted adverbs are in the adverb dictionary 32 (step S404). In this step, when it is determined that all the extracted adverbs are in the adverb dictionary 32 (step S404: YES), the unregistered adverb degree value assignment unit 350 ends the process of this flowchart.

On the other hand, when it is determined that an extracted adverb is not in the adverb dictionary 32 (step S404: NO), the unregistered adverb degree value assignment unit 350 initializes the degree value of such extracted adverb (unregistered adverb) to “1” (reference value) (step S405). As described above, the degree value “1” indicates that the degree of the level of the adverb is at a medium level. This is in the case where the degree value of the adverb is expressed in a range from 0 to 2, and does not apply to the case where the degree value is expressed in another numerical range.

Next, the unregistered adverb degree value assignment unit 350 calculates the similarities between such extracted adverb (unregistered adverb) and all the adverbs in the adverb dictionary 32 (step S406). A method for calculating the similarity of adverb is not specified. For example, the similarity of an adverb may be calculated using distributed representations of the adverbs and their cosine similarities, or may be calculated using hierarchical closeness on a thesaurus, or the like.

The distributed representation of a word is a method for converting one word into a vector (in the case of fruit, the vector includes, for example, size, sweetness, and yellowness when the vector is three-dimensional) having a small number of dimensions, and, when a word is expressed by a distributed representation, the meaning of the word can be represented from the distance and the positional relation between the vectors. As a method of expressing a word by a vector, there are proposed methods including one-hot vector, Word2Vec, fastText, and Bidirectional Encoder Representations from Transformers (BERT).

The thesaurus is a dictionary (close to a synonym dictionary) in which words are organized on the basis of semantic relationships. More specifically, the thesaurus is a system of words organized by focusing on a so-called “relationship between words” such as a relationship between a superordinate concept and a subordinate concept of a word (the concept indicated by the word), an inclusive relation, a relationship between “whole and part”, or a relationship between synonyms included in the same category. It is said that the distance between the vectors represented by the distributed representation reflects a change of the times (passage of time) in meanings and levels of adverbs more than the hierarchical closeness on the thesaurus.

Next, the unregistered adverb degree value assignment unit 350 determines whether the similarity between the extracted adverb and the adverb having the highest similarity is equal to or greater than a preset threshold (step S407). When it is determined that the similarity between the extracted adverb and the adverb having the highest similarity is less than the threshold (step S407: NO), the unregistered adverb degree value assignment unit 350 proceeds to the processing of step S409.

On the other hand, when it is determined that the similarity between the extracted adverb and the adverb having the highest similarity is equal to or greater than the threshold (step S407: YES), the unregistered adverb degree value assignment unit 350 updates the degree value of the extracted adverb set in step S405 (“1” in this example) to the degree value of the adverb having the highest similarity (step S408).

Note that, in step S407, the similarity of the adverb is compared with the threshold, but the threshold may not be set or may be set to “0”. In this case, the determination processing in step S407 can be omitted.

Next, the unregistered adverb degree value assignment unit 350 registers the extracted adverb and the updated degree value in the adverb dictionary 32 (step S409).

Then, when the loop processing A is completed for all the extracted adverbs, that is, after the degree values are assigned to all the unregistered adverbs, the processing of this flowchart is ended.

As described above, an adverb dictionary update apparatus of one aspect of the first embodiment updates an adverb dictionary used for emotion degree estimation, and the apparatus includes: a text data acquisition unit that acquires text data including an object of the emotion degree estimation and stores the text data in a text set storage unit; a text data adverb extraction unit that extracts adverbs related to each piece of text data from the text set storage unit and stores the extracted adverbs in an adverb set storage unit (the text-data-related adverb set storage unit 340); and an unregistered adverb degree value assignment unit that reads a list of the extracted adverbs from the adverb set storage unit, that reads, from an adverb dictionary storage unit, an adverb dictionary including, as a table, registered adverbs and degree values, that updates the adverb dictionary by assigning a degree value to an unregistered adverb among the extracted adverbs while referring to the degree values of the registered adverbs, and that stores the updated adverb dictionary in the adverb dictionary storage unit.

The present embodiment having the above-described configuration can support update and maintenance of the adverb dictionary. In the present embodiment, for example, when a new adverb is extracted from text data that is an analysis result by the emotion analyzer, it is possible to automatically assign the degree value of the adverb with reference to the degree values of the registered adverbs. Furthermore, it is possible to manually or automatically update the adverb dictionary in accordance with the changes of the degree values of adverbs. Furthermore, in a case where the degree value is automatically assigned to an unregistered adverb, it is possible to reduce the cost of maintenance required for manual work of the adverb dictionary.

As described above, by using the adverb dictionary that is appropriately updated with the passage of time by using the adverb dictionary update apparatus of the present embodiment, it is possible to identify the voice of customers about a company, a product, and the like from the SNS in which various types of information are mixed, and to achieve customer satisfaction on the basis of the strength of the emotion analysis result (favorable, uncommitted, and malicious).

### Second Embodiment

A second embodiment is an example of a method in which, as compared with the adverb dictionary update apparatus 300 (see FIG. 3) of the first embodiment, it is considered that temporal changes of words are taken into consideration in the method of calculating the similarity between adverbs. Specifically, in the present embodiment, as a method of calculating the similarity of a distributed adverb, representation model is updated in accordance with the passage of time.

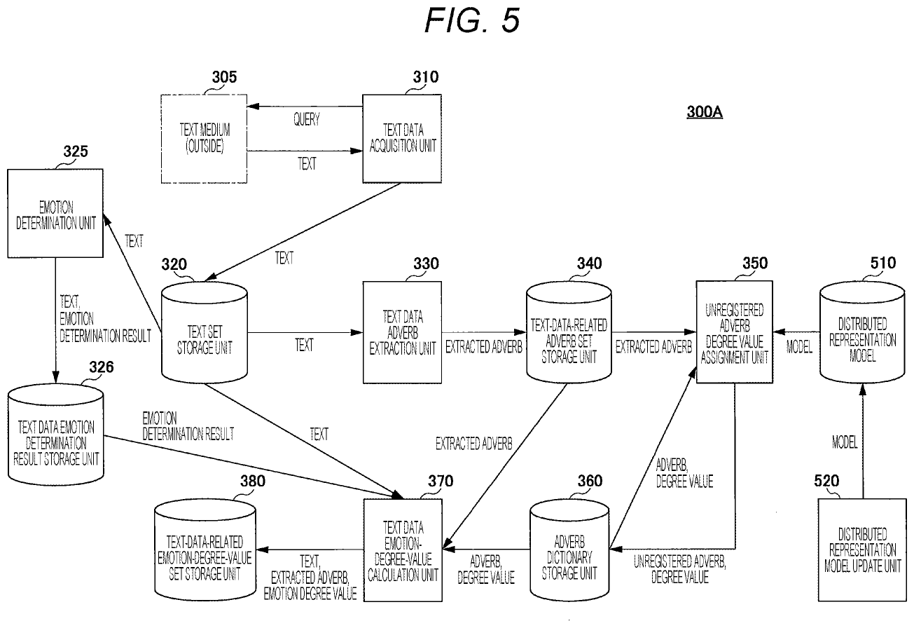

FIG. 5 is a block diagram illustrating an internal configuration example of an adverb dictionary apparatus that realizes an emotion degree estimation method according to the second embodiment of the present invention. An adverb dictionary update apparatus 300A illustrated in FIG. 5 is different from the adverb dictionary update apparatus 300 illustrated in FIG. 3 in that the adverb dictionary update apparatus 300A includes: a distributed representation model 510; and a distributed representation model update unit 520.

The distributed representation model 510 is a natural language processing model that realizes a distributed representation of an adverb. The unregistered adverb degree value assignment unit 350 uses the distributed representation model 510 to produce a distributed representation for each of the extracted adverbs from the text data and the registered adverbs in the adverb dictionary, thereby calculating the similarities of the adverbs.

The distributed representation model update unit 520 has a function of updating the distributed representation model 510 in accordance with the passage of time. The distributed representation model update unit 520 may be configured to manually recreate the distributed representation model 510, or may be a mechanism capable of automatically replacing the distributed representation model 510 with the latest distributed representation model 510.

In an example, the distributed representation model update unit 520 may acquire, as the distributed representation model, an open model published on the Internet or the like. Alternatively, the user may collect a large-scale text data set created at a time when the user wants to create a distributed representation model, and may create the distributed representation model by him or herself.

Next, with reference to FIGS. 6 to 8, a user interface for checking and correcting the degree value of an adverb in each of the above-described embodiments will be described.

FIG. 6 is a diagram illustrating an example of a user interface screen for checking the degree values of adverbs in each embodiment. When the user selects on a menu screen (not illustrated) a mode for checking the degree values of adverbs, the unregistered adverb degree value assignment unit 350 performs processing of displaying a user interface screen 600 for checking the degree values of adverbs. The user interface screen 600 includes: a degree value display area 610; a correction button 620; and an end button 630.

The degree value display area 610 is the area in which an adverb dictionary, that is, the registered adverbs and their degree values are displayed. By displaying a newly registered combination of an adverb and a degree value in color in the degree value display area 610, the newly registered combination of an adverb and a degree value can be visualized. An adverb displayed in color indicates an adverb that a degree value is assigned to but is not checked by the user. Note that the display method is not limited to color display, and may be in any way such as gray display or pop-up display as long as a newly registered combination of an adverb and a degree value can be distinguished from others. When the number of the combinations of adverbs and degree values is large, the hidden combinations of adverbs and degree values can be moved and displayed by moving a slide bar up and down.

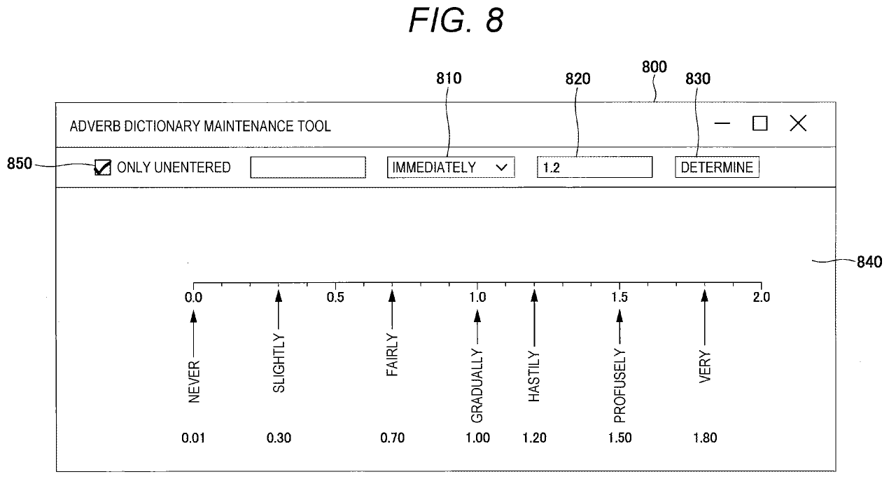

When the user presses the correction button 620, the screen of an adverb dictionary maintenance tool 800 illustrated in FIG. 8 is displayed, and the degree value of the adverb displayed in color in the degree value display area 610 can be corrected.

When the user presses the end button 630, the user interface screen 600 disappears, and the mode for checking the degree value of an adverb is ended. The unregistered adverb degree value assignment unit 350 determines that the check of the degree value of an adverb by the user has been performed, by detecting that the end button 630 is pressed.

In the case where the degree value is not corrected, the user interface screen 600 disappears when the end button 630 is directly pressed without pressing the correction button 620. In the example of FIG. 6, when the user interface screen 600 is displayed the next time, the color display of the newly registered adverb (profusely, often) disappears.

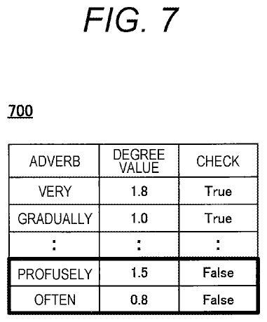

FIG. 7 is a diagram for explaining a function of user's check of an adverb dictionary in each embodiment. A dictionary table 700 of the adverb dictionary (for example, the adverb dictionary 32 in FIG. 2) includes items of “adverb”, “degree value”, and “history of check”. An item (True/False flag) indicating “history of check” is added to the dictionary table 700. The flag “True” indicates that the user has checked the degree value assigned to the adverb, and the flag “False” indicates that the user has not yet checked the degree value assigned to the adverb. When the check of the degree value is not performed (False), the user checks and determines the degree value of the adverb.

FIG. 7 illustrates an example (in a heavy line frame) in which the degree value “1.5” given to the adverb “profusely” and the degree value “0.8” given to the adverb “often” are not checked. When the end button 630 in FIG. 6 described above is pressed, the unregistered adverb degree value assignment unit 350 determines that the check or correction of the degree value has been completed, and switches the “history of check” of the dictionary table 700 of FIG. 7 from “False” to “True”.

Here, it will be described how the update of the adverb dictionary is updated when the distributed representation model 510 illustrated in FIG. 5 is updated and how the True/False flag is handled.
(1) The adverb dictionary is not updated at the timing when the distributed representation model is updated. At this time, the True/False flags do not change, either. Therefore, the degree value is calculated using the new distributed representation model only for the adverb newly registered after the update.
(2) When the degree value of the adverb dictionary is updated using the new distributed representation model, the True/False flag is changed. The adverb dictionary (sets of adverbs and degree values) serving as a reference is prepared as described above, and the degree value of an adverb is updated on the basis of the new distributed representation model. At this timing of updating the dictionary, the reference adverb dictionary may be manually reviewed and updated. In that case, the degree value of an adverb other than the manually reviewed or updated degree value is updated on the basis of the new distributed representation model. The True/False flag of the adverb whose degree value has been updated is changed to “False”.

FIG. 8 is a diagram illustrating an example of a user interface screen of the adverb dictionary maintenance tool 800 in each embodiment. The adverb dictionary maintenance tool 800 is a user interface for correcting an automatically assigned degree value.

The adverb dictionary maintenance tool 800 includes: an adverb display field 810, a degree value input field 820; a determination button 830; an adverb degree value display area 840, and a check box 850. In the example of FIG. 8, in the adverb degree value display area 840 there are displayed the followings: “absolutely” having the degree value of 0.01; “subtly” having the degree value of 0.30; “fairly” having the degree value of 0.70; “gradually” having the degree value of 1.00; “quickly” having the degree value of 1.20; “profusely” having the degree value of 1.50; and “very” having the degree value of 1.80. As described above, in the adverb degree value display area 840, the plurality of adverbs and degree values are linearly disposed in accordance with the degree values. By linearly disposing the plurality of adverbs and degree values, the user can compare an objective adverb with the other adverbs, and can easily input the degree value of the objective adverb.

Here, an example in which a plurality of adverbs and degree values are linearly disposed in accordance with the degree value is described, but the present invention is not limited to this example. For example, a plurality of adverbs and degree values may be disposed in accordance with the degree values as long as the relationships between the plurality of adverbs and the degree value can be easily checked. In one example, it is considered to dispose a plurality of adverbs and degree values in an annular or semicircular shape in accordance with the degree values. Alternatively, such a configuration may be adopted that, in the adverb degree value display area 840, adverbs are displayed in order according to the degree values but the degree values (numerical value) are not displayed. Further, the adverb degree value display area 840 may be removed from the adverb dictionary maintenance tool 800.

The adverb “immediately” is displayed in the adverb display field 810, and the degree value “1.2” is displayed in the degree value input field 820. In this state, when the determination button 830 is pressed, the degree value “1.2” for “immediately” is determined, and “immediately” and the degree value “1.2” are registered in the adverb dictionary.

In addition, when the check box 850 corresponding to “Only unentered” is checked, an adverb whose degree value is not entered (the history of check is in the “False” state) is displayed in the adverb display field 810. For example, in the case of the examples of FIGS. 6 and 7, “profusely” or “often” is displayed. For example, it is possible to operate the pull-down menu button in the adverb display field 810 to select the adverb to be displayed, and, in response to the selection, the degree value is displayed in the degree value input field 820. In the example of FIG. 8, the degree value “1.50” is already assigned to “profusely”.

As illustrated in FIG. 8, the present embodiment includes a correction interface (the adverb dictionary maintenance tool 800) with which it is possible to correct an adverb and a degree value in the adverb dictionary by a user's operation. The correction interface includes: an adverb display area (the adverb display field 810) for displaying an object adverb, a degree value input area (the degree value input field 820) for inputting a degree value corresponding to the object adverb, and a determination button.

In the present embodiment including such an adverb dictionary maintenance tool 800, it is possible to update the degree value of an adverb at any timing in consideration of temporal changes of words. In addition, an adverb not registered in the adverb dictionary can be newly registered, or the automatically assigned degree value can be changed. Note that, when the check box 850 of “Only unentered” is unchecked, it is possible to display (check) the registered adverbs and to correct the degree values.

### Hardware Configuration of a Control System of the Adverb Dictionary Update Apparatus

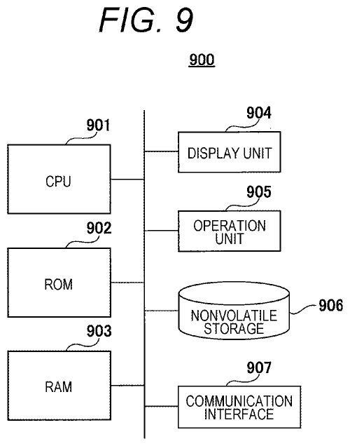

Here, a hardware configuration of a control system of the adverb dictionary update apparatus according to each embodiment of the present invention will be described with reference to FIG. 9.

FIG. 9 is a block diagram illustrating a hardware configuration example of the control system of the adverb dictionary update apparatus. A computing machine 900 illustrated in FIG. 9 is an example of hardware used as a computer. The adverb dictionary update apparatus 300, 300A according to the present embodiment realizes a method for updating an adverb dictionary that is performed by respective ones of the functional blocks illustrated in FIG. 3 in cooperation with each other when the computing machine 900 (computer) executes a program.

The computing machine 900 includes a central processing unit (CPU) 901, a read only memory (ROM) 902, and a random access memory (RAM) 903 that are connected to a system bus. The computing machine 900 further includes: a display unit 904; an operation unit 905; a nonvolatile storage 906; and a communication interface 907.

The CPU 901 reads from the ROM 902 a program code of software for realizing the functions according to the present embodiment and loads the program code in the RAM 903 and executes the program code. Variables, parameters, and the like generated during arithmetic processing of the CPU 901 are temporarily written in the RAM 903, and these variables, parameters, and the like are appropriately read by the CPU 901. The CPU 901 executing the program code read from the ROM 902 realizes the function of each functional block in the adverb dictionary update apparatus 300, 300A. However, instead of the CPU 901, another processor such as a micro processing unit (MPU) may be used.

The functions of the text data acquisition unit 310, the text data adverb extraction unit 330, the unregistered adverb degree value assignment unit 350, and the text data emotion-degree-value calculation unit 370 of the adverb dictionary update apparatus 300, 300A (FIGS. 3 and 5) described above are realized by the CPU 901 executing a program.

The display unit 904 is a monitor such as a liquid crystal display, and displays a graphic user interface (GUI) screen, a result of processing performed by the CPU 901, and the like. The operation unit 905 generates an input signal according to a user's operation and outputs the input signal to the CPU 901. As the operation unit 905, for example, a mouse, a keyboard, and the like are used, and the user can input information and instructions by operating the operation unit 905. The display unit 904 and the operation unit 905 may be integrally configured as a touch panel. The display unit 904 and the operation unit 905 are used for display on and operation of the user interface screen 600 (FIG. 6) for checking the degree values of adverbs, the adverb dictionary maintenance tool 800 (FIG. 8), and the like.

The nonvolatile storage 906 is an example of a recording medium, and can store data to be used by a program, data obtained by execution of the program, and the like. The nonvolatile storage 906 constitutes the following units of the above-described adverb dictionary update apparatus 300, 300A: the text set storage unit 320; the text-data-related adverb set storage unit 340; the adverb dictionary storage unit 360; and the text-data-related emotion-degree-value set storage unit 380 (FIGS. 3 and 5). Furthermore, an operating system (OS) and a program to be executed by the CPU 901 may be recorded in the nonvolatile storage 906. As the nonvolatile storage 906, a hard disk drive (HDD), a solid state drive (SSD), a disk medium using light or magnetism, a semiconductor memory card, or the like is used. Note that a cloud environment can also be used to store acquired text data and data obtained by processing the text data.

As the communication interface 907, a network interface card (NIC) or the like is used, for example. The communication interface 907 is configured to be able to transmit and receive various types of data to and from an external device via a communication network, a dedicated line, or the like, such as a LAN or the Internet, to which a terminal is connected. The function of the text data acquisition unit 310 of the above-described adverb dictionary update apparatus 300, 300A is realized using the communication interface 907.

### Modifications

Note that the present invention is not limited to the above-described embodiments, and it is obvious that various other application examples and modifications can be made without departing from the gist of the present invention described in the claims. For example, in the above-described embodiments, the configurations have been concretely described in detail for easy understanding of the present invention, and the present invention is not necessarily limited to an embodiment including all the described components. In addition, a part of the configuration of each embodiment can be replaced or added with another component, or can be removed.

In addition, some or all of the above-described configurations, functions, processing units, and the like may be realized by hardware, for example, by being designed as an integrated circuit. As the hardware, it is possible to use a processor device in a broad sense such as a field programmable gate array (FPGA) or an application specific integrated circuit (ASIC).

Furthermore, each component of the adverb dictionary update apparatuses according to the above-described embodiments may be realized in any hardware as long as each piece of hardware can transmit and receive information to and from each other via a network. Furthermore, the processing performed by a certain processing unit may be realized by one piece of hardware or may be realized by distributed processing by a plurality of pieces of hardware.

In addition, in the above-described embodiments, the control lines and the information lines that are considered to be necessary for the sake of description are illustrated, and not all the control lines and the information lines necessary for a product are illustrated. It may be considered that almost all the components are actually connected to each other.

### REFERENCE SIGNS LIST

11 emotion analyzer analysis result
200 emotion degree estimation method
300, 300A adverb dictionary update apparatus
305 text medium
310 text data acquisition unit
320 text set storage unit
330 text data adverb extraction unit
340 adverb set storage unit
350 unregistered adverb degree value assignment unit
360 adverb dictionary storage unit
370 text data emotion-degree-value calculation unit
380 emotion-degree-value set storage unit
510 distributed representation model
520 distributed representation model update unit
600 user interface screen for checking a degree value
700 dictionary table
800 adverb dictionary maintenance tool

1. An adverb dictionary update apparatus that updates an adverb dictionary used for emotion degree estimation, the apparatus comprising:
a text data acquisition unit that acquires text data including an object of the emotion degree estimation and stores the text data in a text set storage unit;
a text data adverb extraction unit that extracts adverbs related to each piece of text data from the text set storage unit and stores the extracted adverbs in an adverb set storage unit; and
an unregistered adverb degree value assignment unit that reads a list of the extracted adverbs from the adverb set storage unit, that reads, from an adverb dictionary storage unit, an adverb dictionary including, as a table, registered adverbs and degree values, that updates the adverb dictionary by assigning a degree value to an unregistered adverb among the extracted adverbs while referring to the degree values of the registered adverbs, and that stores the updated adverb dictionary in the adverb dictionary storage unit.

2. The adverb dictionary update apparatus according to claim 1, wherein the unregistered adverb degree value assignment unit calculates a degree of similarity between the unregistered adverb and all the registered adverbs by using a distributed representation, and assigns, to the degree value of the unregistered adverb, a degree value of the registered adverb having a highest degree of similarity.

3. The adverb dictionary update apparatus according to claim 2, wherein
the unregistered adverb degree value assignment unit compares a degree of similarity between the unregistered adverb and the registered adverb having the highest degree of similarity with a predetermined threshold,
when the degree of similarity is equal to or greater than the predetermined threshold, the unregistered adverb degree value assignment unit assigns, to the degree value of the unregistered adverb, the degree value of the registered adverb having the highest degree of similarity, and
when the degree of similarity is less than the threshold value, the unregistered adverb degree value assignment unit assigns, to the degree value of the unregistered adverb, a predetermined reference value.

4. The adverb dictionary update apparatus according to claim 1, further comprising:
a distributed representation model that realizes a distributed representation of an adverb; and
a distributed representation model update unit that updates the distributed representation model.

5. The adverb dictionary update apparatus according to claim 1, further comprising a correction interface with which adverbs and the degree values in the adverb dictionary are corrected by a user's operation,
Wherein
the correction interface includes:
an adverb display area in which an object adverb is displayed,
a degree value input area to which a degree value corresponding to the object adverb is input, and
a determination button.

6. The adverb dictionary update apparatus according to claim 5, wherein the correction interface further includes an area in which a plurality of adverbs and a plurality of degree values are disposed in accordance with the plurality of degree values.

7. The adverb dictionary update apparatus according to claim 1, further comprising a text data emotion-degree calculation unit that reads each piece of text data from the text set storage unit, reads the extracted adverbs from the adverb set storage unit, reads the adverb dictionary from the adverb dictionary storage unit, calculates a degree value of emotion of the each piece of text data, and stores the each piece of text data, the extracted adverbs, and the degree values of emotion in an emotion-degree-value set storage unit.

8. An adverb dictionary update method performed by an adverb dictionary update apparatus that updates an adverb dictionary used for emotion degree estimation, the method comprising:
a process of acquiring text data including an object of the emotion degree estimation and storing the text data in a text set storage unit;
a process of extracting adverbs related to each piece of text data from the text set storage unit and storing the extracted adverbs in an adverb set storage unit;
a process of reading a list of the extracted adverbs from the adverb set storage unit, reading, from an adverb dictionary storage unit, an adverb dictionary including, as a table, registered adverbs and degree values, updating the adverb dictionary by assigning a degree value to an unregistered adverb among the extracted adverbs with reference to the degree values of the registered adverbs, and storing the updated adverb dictionary in the adverb dictionary storage unit; and
a process of reading each piece of text data from the text set storage unit, reading the extracted adverbs from the adverb set storage unit, reading the adverb dictionary from the adverb dictionary storage unit, calculating a degree value of emotion of the each piece of text data and storing the each piece of text data, the extracted adverbs, and the degree values of emotion in the emotion-degree-value set storage unit.
